(19) United States
(12) Patent Application Publication
(10) Pub. No.: US 2026/0022702 A1
(43) Pub. Date: Jan. 22, 2026

(54) HYBRID COMPRESSOR

(71) Applicant: Garrett Transportation I Inc., Torrance, CA (US)

(72) Inventor: Saphir Faid, Rolle (CH)

(73) Assignee: Garrett Transportation I Inc., Torrance, CA (US)

(21) Appl. No.: 18/776,489

(22) Filed: Jul. 18, 2024

(51) Int. Cl. F04C 29/00; F04C 18/02; F04C 28/02; F04D 25/06

(52) U.S. Cl. CPC F04C 29/005; F04C 18/0215; F04C 28/02; F04D 25/06

(57) ABSTRACT

A hybrid compressor system is set out wherein selection between engaging a first compressor and a second compressor is linked to the flow of a gas or liquid communicated in the system, the outlet of the first and second compressors being in the same direction; as well as optimizing for lower flow rate and higher flow rate. Such may apply when the first compressor is a scroll compressor and the second compressor is a centrifugal compressor. A coupling unit may be used to selectively couple at the first compressor to an electric motor arranged and configured to simultaneously drive both the first and the second compressors. The coupling unit may be a one way bearing or a sprag clutch. Bearings may be included on a shaft of the electric motor between the motor and the compressors, and the bearings may be magnetic or roller bearings.

### BACKGROUND OF THE INVENTION

### Field of the Invention

The presently claimed invention is directed to the field of compressors, namely hybrid compressors, and in particular to the application of different types of compressors in a single unit that is stand-alone and portable or integrated into a larger system by way of a refrigerant circuit based upon a desired temperature load. The presently claimed invention is further directed to a method for affecting temperature change via the temperature load. The presently claimed invention is further directed to a vapor compressions systems. Compressors are well known mechanical devices that increase the pressure of a gas or on a fluid by reducing its volume and may be used to supply air, coolant and/or the like at the increased pressure to a particular location. The compressors are configured and arranged to provide a particular flow for a particular application, the compressors being rated or otherwise distinguished by efficiency, operating pressure, spinning speed and other performance matrices. The compressors may be spun by an electric motor, itself powered by an inverter receiving a direct current input. Other power types, sources and the like may be substituted by the skilled person as a matter of design choice. Two common compressors employed in hybrid compressors are scroll compressors and centrifugal compressors.

Scroll compressors are often employed in refrigerant circuits, scroll compressors being devices for compressing air or refrigerant through the use of two interleaving scrolls to pump, compress or pressurize fluids such as liquids or gases. In operation, typically, one of the scrolls is fixed, while the other orbits eccentrically without rotating, thereby trapping and pumping or compressing pockets of fluid between the scrolls.

By contrast, centrifugal compressors achieve pressure by adding energy to the continuous flow of fluid through the use of a rotating rotor or impeller. A substantial portion of this energy is kinetic which is converted to increased potential energy/static pressure by slowing the flow through a diffuser. The static pressure rise in the impeller is roughly equal to the rise in the diffuser. Accordingly, centrifugal compressors operate at higher speeds than scroll compressors as well as produce more pressure, thereby making them appropriate for other applications than the scroll compressors such as affecting greater temperature changes.

### Description of Related Art

United States patent application publication US2021/003315 (hereinafter Carrier) is directed to a dual compressor heat pump comprising a heat pump circuit including two compressors, a scroll compressor 22A and a centrifugal compressor 22B, both being arranged to be spun by an electric motor 228. The two compressors are oriented to produce a flow in different and opposite directions, when activated, and as depicted in the figures. Accordingly, in operation when the choice arises between engaging one of the two compressors, such choice is based upon or linked to the appropriateness of the resulting different flow-through in the system generated by one or the other compressor. FIG. 1 depicts a vapor compression system with flow arrows showing operation in a cooling mode. By contrast, FIG. 2 depicts the system with flow arrows showing operation in a heating mode. Carrier only operates one compressor at a time, the operation depending upon the mode; namely, the scroll compressor 22A is employed in the cooling mode while the centrifugal compressor 22B is employed in the heating mode. Each compressor includes a suction port or inlet (24A, 24B) and discharge port or outlet (26A, 26B) arranged to be fed by suction lines or conduits (28A, 28B) that pass refrigerant from the discharge lines or conduits (30A, 30B). Control valves (32A, 32B) are arranged along the discharge conduits to selectively block the discharge conduits when the respective compressor is not in operation. Accordingly, in the cooling mode, valve 32A is opened while valve 32B is closed; while, in the heating mode, the opposite is true, namely, valve 32A is closed while valve 32B is opened. To facilitate the aforementioned, the scroll compressor suction line 28A merges with the centrifugal compressor' discharge 30B line at junction 34. Additionally, the scroll compressor discharge line 30A merges with centrifugal compressor suction line 28B at junction 36. Accordingly, the type of compressor is selected to enable a particular mode. The heating mode would require a significantly higher pressure ratio than the cooling mode thus leading to the centrifugal compressor operating at 1.25 to 10 times that of the scroll compressor. A controller is used to control the operation of the two compressors separately, namely, the two compressors would not be run at the same time but rather be selected to run based upon their link to the different flow throughs in the system consistent with the aforementioned distinct operating mode, the different operations enabled by individual motors coupled to individual compressors or a single motor selectively coupled to one of the two compressors via a clutch arrangement.

As is known in the art, scroll compressors have a high volumetric efficiency making them quite suitable for low cooling loads. When applied in a vehicle setting, a low cooling load would be that which is required when cooling the vehicle cabin. The same may be said for heating the vehicle cabin. However, for higher cooling loads, such as that which may be required for cooling a motor vehicle battery during fast charging, scroll compressors have performance limitations as they become bulky and cause NVH problems, namely audible noise or tangible vibrations problems with the harshness or rough transmission of the vibrations throughout at least a local area of the vehicle.

As is further known in the art, centrifugal compressors can achieve higher performance for a given size or can be much smaller for a given power than scroll compressors. Accordingly and by way of example, for high cooling loads, such as the aforementioned battery cooling (possibly further exacerbated by high ambient temperature), centrifugal compressors are of considerable performance benefit over scroll compressors. However, centrifugal compressors have relatively low efficiency when operating with respect to low cooling loads generation.

As applied for example to refrigeration-type circuits, making use of both scroll and centrifugal compressors typically requires also making use of separate electric motors to run the individual compressors at appropriate speeds for the particular compressor to function as intended within the circuit. Typically, scroll compressors are operated at much slower speeds than centrifugal compressors. Use of individual motors entails greater complexity and costs which is undesirable in such a system. Where a single motor and clutch arrangement is employed, as in Carrier, greater complexity and costs remain with the additional burdens for operation being placed on the controller (and support therefor within the system) to appropriately engage and disengage the desired compressor. Carrier is further restricted to the orientation of the respective generated load flow being in opposite directions thus imputing certain design and implementation obstacles.

Accordingly, a need exits within the art for an effective hybrid compressor unit having reduced complexity and costs along with design and/or implementation flexibilities for inclusion within temperature load related circuits and the like.

### BRIEF SUMMARY OF THE INVENTION

The presently claimed invention is directed to a hybrid compressor system including first and second compressors run by a single motor whose generated load flow is oriented in the same direction. A coupling unit may be included to selectively couple one of the first and second compressors with the motor.

The presently claimed invention may further include a power source configured and arranged to power the motor. The motor may be a high-speed electric motor. Accordingly, the power source may be electrical, such as an inverter receiving a DC input as would be the case in the event of application of the presently claimed invention in a motor vehicle.

The motor may be configured to turn a shaft when powered by the power source. The first and second compressors may each be mechanically and selectively coupled to the shaft so as to generate output temperature loads, arising from appropriate inputs, when engaged by the turning or rotating shaft. The first compressor may be configured to deliver a first temperature (cooling or heating) load. A coupling unit may be configured and arranged to mechanically couple the first compressor to the shaft. The second compressor may be configured to deliver a second temperature (cooling or heating) load which is greater than the first temperature load. The electric motor, the first compressor and the second compressor may be arranged coaxially. The flow orientation of the generated temperature loads may be in a same direction.

The coupling unit may be configured to couple and decouple the first compressor from the shaft such that when the first compressor is coupled to the shaft, the electric motor spins at a speed matching characteristics of the first compressor and when the first compressor is decoupled from the shaft, the shaft is free to spin at other speeds. The second compressor is configured and arranged to rotate at the same time as when the first compressor rotates. When the first compressor is decoupled from the shaft, the shaft is configured to rotate faster, for example 10-15 times faster, than when the first compressor is coupled to the shaft. The faster rotating speeds are consistent with the operational characteristics of the second compressor. Alternatively, a second decoupling unit may be associated with the second compressor to selectively couple and decouple the second compressor from the shaft of the electric motor.

The coupling unit may be a one-way bearing or a sprag clutch and the first compressor may be configured and arranged to automatically decouple from the shaft when the motor shaft changes rotational direction. Alternatively, a controlled may be arranged in communication with the present system to instruct the coupling and decoupling by the coupling unit.

In an embodiment, the hybrid compressor system is configured such that the first compressor and the second compressor may be arranged in a dual loop thermal management circuit such that the first compressor is configured and arranged to serve a first loop and the second compressor is configured and arranged to serve a second loop. In another embodiment, the first and second compressors may be arranged in a single loop thermal management circuit.

In an embodiment, the presently claimed invention is directed to a vapor compression system that combines a small compressor, such as a scroll compressor, with a large compressor, such as a centrifugal compressor, in a single unit. A single electric motor is provided to drive both the small and the large compressors. The one electric motor includes a shaft selectively and mechanically coupled to the small compressor such that it, along with the large compressor, are driving at the same time by the electric motor and in particular the shaft of the electric motor. The small compressor is configured to run at slower speeds than the large compressor. At low speeds, both the small and large compressor are powered by the electric motor shaft. For high speeds, the small compressor becomes decoupled by virtue of a coupling unit such as a clutch arranged between the motor and the small compressor. Accordingly, when the electric motor is coupled to the small compressor, the electric motor turn the shaft so as to be consistent with the operating parameters of the small compressor. Although the large compressor is also being run by the shaft, the large compressor is being operated at low speeds thereby not generating any significant losses thus obviating the need to decouple it from the electric motor. As such, when the small compressor is decoupled from the electric motor, the shaft may then be made to turn faster than during the aforementioned coupling, the faster turning being more consistent with the operating parameters of the large compressor. The large compressor operating parameters may entail shaft rotating speed that are 10 to 15 times faster than the operating parameters of the small compressor. Bearings may be provided on the shaft, the bearings being capable of running at both low and high speeds.

In another embodiment, a method for affecting temperature change is also described, the method including the steps of selectively arranging a first and a second compressors on a shaft of an electric motor such that the one motor powers both compressors. A coupling unit enables the coupling and decoupling of the first and second compressors from the shaft. The coupling unit is responsive to the load demands the method seeks to fulfill, namely, for low loads, both compressors are arranged to run at the same time while for higher loads the first compressor, being smaller than the second compressor, is decoupled from the electric motor so that the motor may now operate at speeds consistent with the operational parameters of the second compressor without damage to and/or loss from the first compressor. The method is applicable for single and dual loop thermal management circuits and the loads generated by the first and second compressors are oriented in the same direction.

### BRIEF DESCRIPTION OF THE SEVERAL VIEWS OF THE DRAWINGS

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure. An advantageous embodiment of the present invention is set out below with reference to the accompanying figures, wherein:

FIGS. 1A and 1B depict operational overviews of the instant hybrid compressor system within a motor vehicle in a dual loop (FIG. 1A) and single loop (FIG. 1B) thermal management circuit;

FIG. 2 depicts a box diagram of the instant hybrid compressor system;

FIG. 3 depicts an embodiment of the presently claimed system; and

FIG. 4 depicts a method according to an embodiment of the present invention.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C.

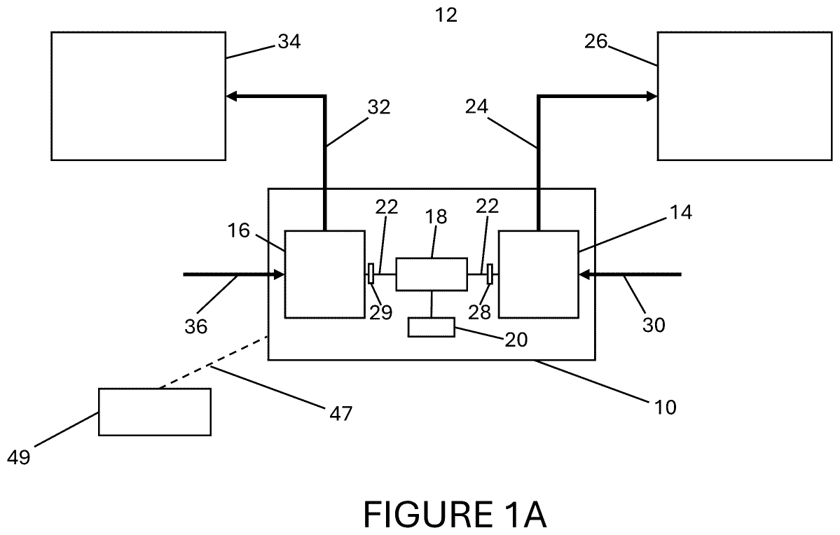

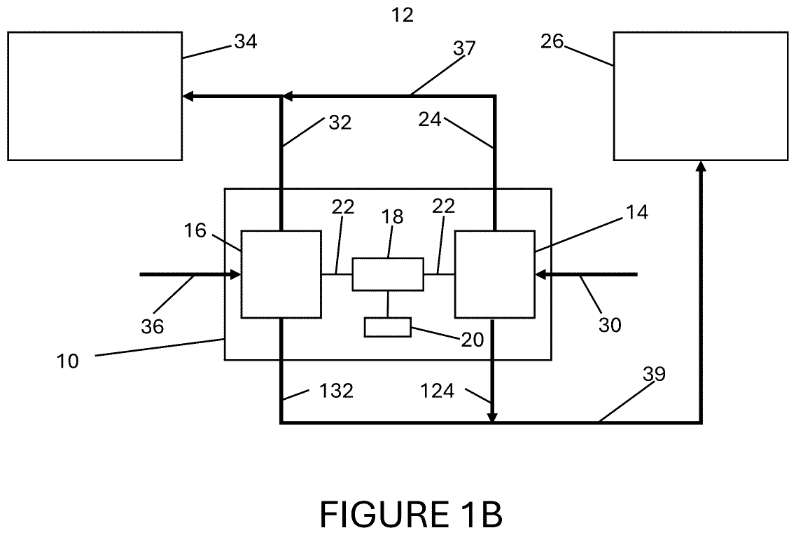

FIGS. 1A and 1B depict example applications of the instant hybrid compressor system in a double (FIG. 1A) and single (FIG. 1B) thermal management circuit respectively. The arrangement may apply to the instant vapor compression system and instant method mutatis mutandis. While the hybrid compressor system may be made to be portable with battery powered operations facilitating the portability functionality, FIGS. 1A and 1B depict the present system 10 within a motor vehicle 12 powered by an inverter 20 receiving DC power from a source (not shown). A controller 49 is depicted in communication 47 with the present hybrid compressor system to enable and otherwise control its operation and functionality. The controller may be powered by the inverter or other means as envisioned by the skilled person. Regarding the inverter, other power sources and/or arrangements for powering the single electric motor 18 may be implemented by way of design choice to the skilled person. Additionally, in other embodiments, the number of electric motors may be different.

The present system 10 further includes a small or first compressor 14 and a large or second compressor 16 arranged on opposite sides of the electric motor 18. The electric motor includes a shaft 22 extending coaxially from the motor's lateral sides. Each of the first and second compressors is arranged in mechanical connection with the shaft 22, such that when the electric motor turns the shaft, both the first and the second compressor are engaged to operate at the same time. Other shaft and compressor arrangements made be made by way of design choice known to the skilled person. A check valve (not shown) may be arranged on or proximate to at least the second compressor so as to prevent reverse flow back into the second compressor. Likewise, a check valve of same arrangement and functionality may also be arranged with respect to the first compressor.

A coupling unit or clutch may be arranged so as to selectively engage, namely, couple and decouple, a one of the two compressors. For example and in keeping with the present systems depicted in FIGS. 1A and 1B, a coupling unit 28 may be arranged between the electric motor 18 and the first compressor 14, and another coupling unit 29 may be arranged between the electric motor 18 and the second compressor 16. Other arrangements to the aforementioned may be implemented by the skilled person as a matter of design choice. One or both of the coupling units may be a one way bearing or sprag clutch which is known to the skilled person for its coupling and decoupling depending upon direction of rotation of the shaft. In operation, the one way bearing or sprag clutch obviates the need for a complete control unit for executing the aforementioned coupling and decoupling. Alternatively, the control unit 49 may be in communication with one or both of the coupling units to facilitate their selective coupling and uncoupling actions.

When the first compressor is coupled to the electric motor, the shaft is made to spin at a speed consistent with the parameters of the first compressor. The controller may be used to control the operation of the electric motor. The shaft may be spun at a select speed regardless of whether the second compressor is also coupled to the electric motor. When the first compressor is decoupled from the electric motor while the second compressor is still coupled to the electric motor, the shaft may be made to spin at a speed consistent with the parameters of the second compressor thus increasing and/or maximizing output efficiency of the second compressor while having no effect on the first compressor along with the first compressor having no effect on the aforementioned given the decoupling. Likewise, when both the first and second compressors are coupled to the electric motor, the shaft may be made to turn at speeds consistent with the operating parameters of the first compressor. This has the effect of increasing and/or maximizing output efficiency of the first compressor. Even though the second compressor is also coupled to the electric motor and is engaged by the shaft spinning at speeds more suitable for the first compressor, the second compressor will also have little to no negative effect or loss on the output of the first compressor and/or the efficiency of the system. Smaller compressors operate at slower speeds than larger ones. Typically, a larger compressor will operate at speeds ten to fifteen times faster than smaller ones. Smaller compressors cannot be effectively run at speeds consistent with larger compressors, whereas larger compressors may be run at the slower speeds consistent with the smaller compressors, albeit with essentially little to no contribution to the system by way of load output. Concurrently, the larger compressors run at the smaller compressor slower speeds will not generate a loss or efficiency reduction to the system thus leaving their operation of little to no consequence.

In FIG. 1A, the system 10 is depicted in a dual loop thermal management circuit with first flow arrow 24 leading from the first compressor 10 to the vehicle's cabin interior 26 so as to selectively effect the climate of the interior by directing a load of gas, such as air, of a select temperature, from the first compressor into the cabin interior 26. The air of a select temperature may be fed 30 into the first compressor from a heat exchanger or the like (now shown). The source of the air and its temperature is a matter of design choice. Other medium known to the skilled person to be a basis for generating a temperature load may be fed into the first compressor and the second compressor by means known to the skilled person.

Second flow arrows 32 depict the directing of a gas, such as air, of a select temperature from the second compressor to a vehicle battery 34, the air here also being fed from a heat exchanger or the like (not shown), the choice and type of source of the air and its temperature also being a matter of design. While discussed within the context of air, the present system is not limited to operating with gas and may also be made to operate with a fluid and the like.

In FIG. 1B, the system is depicted in a single loop thermal management circuit 37 with both the first and second compressors serving the vehicle battery 34 as depicted by the joining arrows. Likewise, a single loop thermal management circuit 39 is depicted by both arrows from the first and second compressors respectively serving the vehicle interior 26. The coupling units 28 and 29, as well as controller 50, are not depicted in FIG. 1B for ease of reference. Because the bearings must operate at both the low speeds consistent with the first compressor and the high speeds consistent with the second compressor, the bearings may be one of magnetic bearings and roller bearings. Other types of bearings may be substituted for the aforementioned provided the substituted bearings perform as do the magnet and roller bearings within the context of the presently disclosed system, including one-way bearings whose implementations may substitute for inclusion of a coupling unit or clutch.

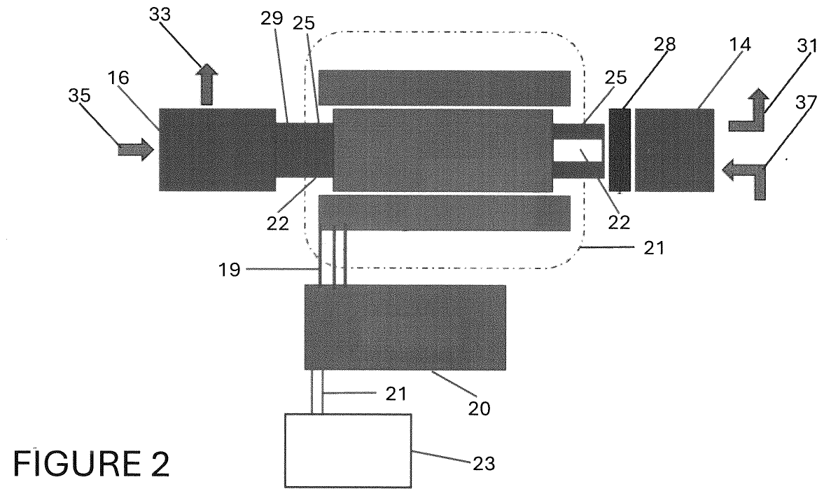

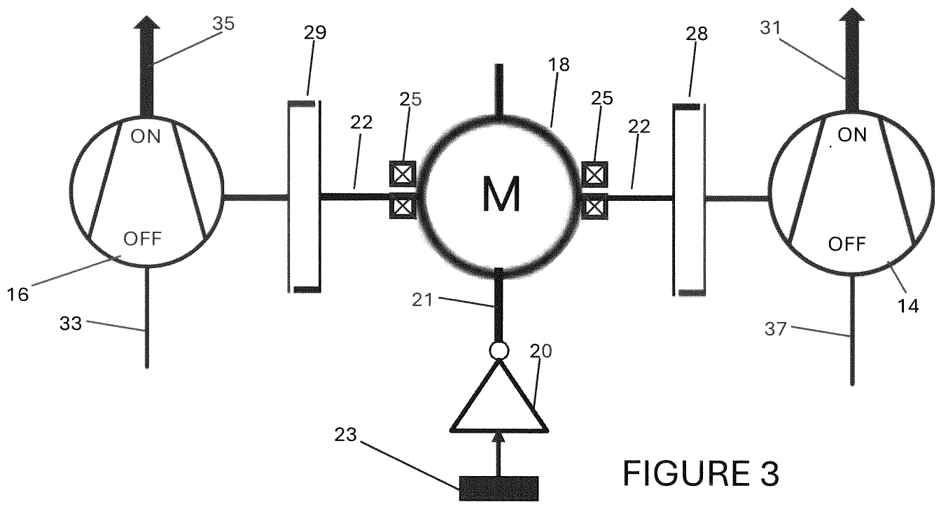

FIG. 2 depicts an embodiment of the instant hybrid compressor system introduced in FIGS. 1A and 1B wherein like reference numerals refer to like parts. As depicted in FIG. 2, the second compressor 16 may be a 1 stage or 2 stage centrifugal compressor. The inverter 20 is configured and arranged to receive a DC input 21 from an appropriate source 23 and power (19) electric motor 18. The electric motor 18 (depicted with three separate boxes indicative of a standard rotor/stator combination with the choice of electric motor type being a matter of design choice for the skilled person) includes shaft 22 extending from a left and right lateral sides of the motor (with respect to the direction of the Figure). The shafts are connected at one end to the electric motor and at the opposite end to the first compressor 14 and second compressor 16 respectively such that when in operation, the shaft is arranged to turn and power both compressors at the same time. Bearings 25 are arranged on the left and right sides of the electric motor so as to engage the shaft from the top and bottom. A functional view of the bearings may be found in FIG. 3. Arranged on the shaft in between the bearings and the compressors are coupling unit 28, arranged on shaft 22 between motor 18 and first compressor 14, and coupling unit 29, arranged on shaft 22 between motor 18 and second compressor 16. Arrows 38 depict locations where the bearings may be arranged. The coupling unit may be a clutch or similar as envisioned by the skilled person. As depicted, the shaft, bearing and coupling unit are depicted separately on the right side of the electric motor 18 (with respect to the direction of FIG. 2) and together as one block on the left side of the electric motor 18 (with respect to the direction of FIG. 2). The outlets of the first and second compressor flow in the same direction. As depicted, first compressor 14 outlet 31 is in the same direction as second compressor 16 outlet 33. Likewise, first compressor input 35 and second compressor input 37 also flow in the same direction.

Turning now to FIG. 3, an embodiment of the present invention is depicted wherein like reference numerals refer to like parts. As shown, electric motor 18 is powered 21 by inverter 20 which receives power from a power source 23. Shaft 22 extends from a left and right side lateral side of motor 18. Bearings 25 are arranged on either side of shaft 22 and on the left and right sides of motor 18. Coupling units 28 and 29 are arranged along shaft 22 between the motor 18 and the first compressor 14 and second compressor 16 respectively. Both compressors include a load outputs 31, 35, respectively, in a same direction as gas/air inputs 37, 33 respectively.

The bearings 25 are depicted on opposing sides of shaft 22 between electric motor 18 and the first and second compressors respectively. The bearings may be magnetic bearings as well as roller bearings in order to accommodate operation at both low and high speeds. Other bearings as envisioned by the skilled person may be employed. A coupling unit such as a clutch (28, 29) is depicted between the electric motor 18 and the first compressor 14 (28) as well as between the electric motor 18 and the second compressor 16 (29) respectively. In place of a coupling unit, a one-way bearing may be employed. Namely, the coupling unit between the electric motor and first compressor may be a one way bearing which operates to couple and decouple as understood by the skilled person. As applied to the presently claimed system, the one way bearing operates to couple and decouple at least the first compressor should the shaft 22 change direction. Where a second one way bearing is arranged between the electric motor and the second compressor, a shaft change in direction would likewise serve to couple or decouple the second compressor.

A controller may be supplied to enable operation of the present system. By way of example and returning to FIG. 1A, a controller 49 is depicted in communication 47 with system 10. The controller is arranged outside of the system 10 and within motor vehicle 12. The controller may comprise any means which enable communication of instruction to the electric motor to operate as described herein. Such means is not limited to wired connections and may be wireless, remote, analog/digital, etc. as envisioned by the skilled person. Additional components related to the controller and its operation, such as input/output, processing means, display, etc. may be included as would be envisioned by the skilled artisan in affecting the aforementioned respective functionality with the controller.

By way of another embodiment, the present system may be a vapor compression system including at least one heat exchanger in addition to and in operational connection with an inverter; an electric motor with shaft; a first compressor configured, as articulated above, to deliver a first temperature load; a coupling unit configured and arranged to mechanically couple the first compressor to the electric motor; and a second compressor configured to deliver a second temperature load which is greater than the first temperature load. By temperature, as used above, it is meant here to be heating or cooling. Essentially, the vapor compression system operates similarly to the present hybrid compressor system with the addition of a heat exchanger. In the vapor compression system the electric motor, the first compressor and the second compressor are arranged coaxially to one another; and the first compressor and the second compressor are configured and arranged to generate and push a temperature load flow oriented in a same direction. Furthermore, the coupling unit is further configured to couple and decouple at least the first compressor based upon system flow through requirements. Like elements in both the vapor compression system and hybrid compressor system operate in essentially a same manner.

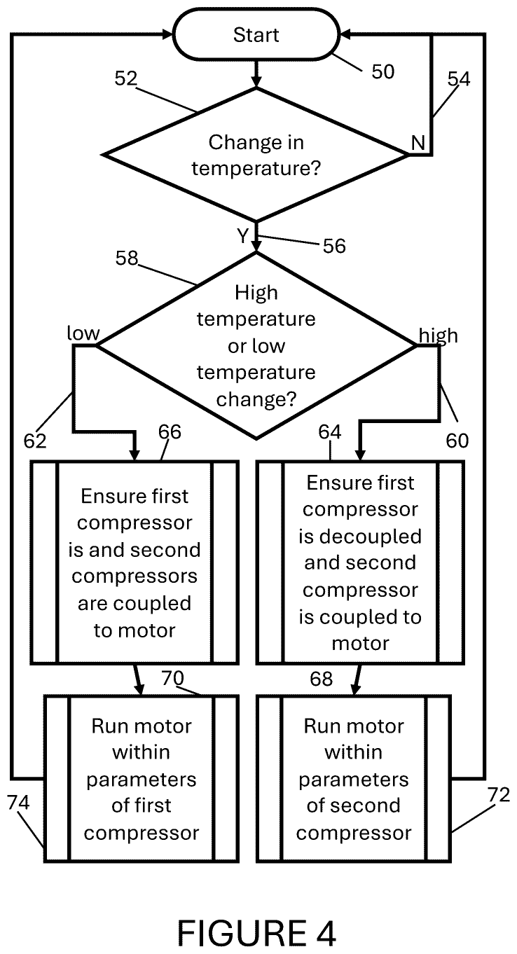

In operation, the controller facilitates and/or enables the selection of which of the first and second compressors to operate. Such decision is made, at least in part, based on demand for different flows of gas or liquid through the system; such further being in accordance with a method set out in FIG. 4. The method starts 50 and proceeds to a consideration 52 as to whether a change of temperature in a particular location is required. If no change is required, the method loops (54) back to start. If a change in temperature at the location is required, a determination is made (58) as to whether a high temperature change or a low temperature change is required. The specific temperatures qualifying as high and low, in regards to the present method, is a matter of design choice known to the skilled person as well as is application dependent. By way of example, a high temperature includes that which would be required to cool a vehicle battery during charging, whereas a low temperature includes that which would be required to cool a vehicle's interior space. If the required temperature change is low (62) the method proceeds in ensuring (66) the coupling of at least the first compressor to the electric motor. The second compressor may be coupled or left uncoupled to the electric motor. The method then proceeds (70) to running the motor within the operating parameters of the first compressor so as to generate and deliver the necessary temperature flow loads for affecting the required temperature change; such being in the form of liquid, gas and the like as envisioned by the skilled person. Afterwards the method returns to start. In the event a high change of temperature is required (60), it is ensured (64) that the second compressor is coupled to the electric motor while the first compressor is decoupled to the electric motor. The motor is then made to run (72) within the parameters of the second compressor so as to affect the required temperature change. Afterwards the method returns to start. The aforementioned coupling may be enabled by the respective compressor mechanically connecting to the shaft of the electric motor such that rotational energy imparted on the shaft by the electric motor is transferred to the now coupled compressor. Coupling units may be used to effect the aforementioned as detailed above. The outputs of the first compressor and the second compressor are in the same direction within a single or dual loop thermal management circuit. The aforementioned method may be implemented by way of an appropriate controller in appropriate communication with some or all of the aforementioned as well as be configured to receive automatic and/or manual operating instruction. Understood within the aforementioned method is the optional inclusion of providing the aforementioned structural elements into and/or connected to an environment whose temperature is to be affected.

Since the apparatuses and methods described in detail above are exemplary embodiments, they can be modified in a customary manner by a person skilled in the art to a wide extent without departing from the scope of the invention. In particular, the mechanical arrangements and the size ratios of the individual elements relative to one another are merely exemplary.

What is claimed is:

1. A hybrid compressor system for generating temperature loads comprising:
an electric motor comprising a shaft;
a first compressor arranged to be selectively engaged by the shaft and configured to generate a first temperature load;
a coupling unit arranged between the first compressor and the electric motor, the coupling unit configured to selectively couple and decouple the first compressor from the shaft;
a second compressor arranged to be selectively engaged by the shaft and configured to generate a second temperature load which is greater than the first temperature load; and
wherein generated flow of the first temperature load and generated flow of the second temperature load is oriented in a same direction.

2. The hybrid compressor system according to claim 1, wherein the first compressor is arranged coaxially with the second compressor.

3. The hybrid compressor system according to claim 1, wherein the first compressor and the second compressor are arranged on either same or different sides of the electric motor.

4. The hybrid compressor system according to claim 1, further comprising a second coupling unit arranged on the shaft between the electric motor and the second compressor, the second coupling unit configured to selectively couple and decouple the second compressor from the shaft.

5. The hybrid compressor system according to claim 4, wherein when the first compressor is decoupled from the shaft, the shaft rotates faster than when the first compressor is coupled to the shaft.

6. The hybrid compressor system according to claim 5, wherein when the shaft is configured such that when the shaft is decoupled from the scroll compressor, the shaft rotates at 10-15 times faster than when the shaft is coupled to the scroll compressor.

7. The hybrid compressor system according to claim 4, wherein at least one of the coupling unit and the second coupling unit is a one-way bearing or a sprag clutch.

8. The hybrid compressor system according to claim 7, wherein the first compressor is configured and arranged to automatically decouple from the shaft when the motor shaft changes rotational direction.

9. The hybrid compressor system according to claim 1, further comprising a controller arranged in communication with the electric motor, the controller configured to receive commands and cause the electric motor to operate in accordance with the commands, the commands comprising a first command to operate the electric motor consistent with operational parameters of the first compressor and/or a second command to operate the electric motor consistent with operational parameters of the second compressor.

10. The hybrid compressor system according to claim 9, wherein the coupling unit is configured to decouple the first compressor from the shaft when the controller executes the second command.

11. The hybrid compressor system according to claim 1, wherein the first compressor is a scroll compressor and the second compressor is a centrifugal compressor.

12. The hybrid compressor system according to claim 1, further comprising an inverter configured and arranged to power the electric motor and wherein the electric motor is a high-speed electric motor.

13. The hybrid compressor system according to claim 1, wherein the first compressor and the second compressor are arranged in a dual loop thermal management circuit such that the first compressor is configured and arranged to serve a first loop and the second compressor is configured and arranged to serve a second loop.

14. The hybrid compressor system according to claim 13, wherein:
the first loop is configured and arranged to adjust a temperature in a cabin of a motor vehicle; and
the second loop is configured to adjust a temperature of a battery of the motor vehicle.

15. The hybrid compressor system according to claim 1, further comprising a check valve arranged on or proximate to the second compressor, the check valve configured to prevent reverse flow through the second compressor.

16. The hybrid compressor system according to claim 1, wherein the first compressor and the second compressor are arranged in a single loop thermal management circuit.

17. The hybrid compressor system according to claim 1, further comprising a plurality of bearings arranged on the shaft between the electric motor the first compressor and the second compressor.

18. The hybrid compressor system according to claim 14, wherein the bearings are one of magnetic bearings and roller bearings.

19. A vapor compression system comprising:
at least one heat exchanger;
an inverter;
an electric motor comprising a shaft;
a first compressor configured to deliver a first temperature load;
a coupling unit configured and arranged to mechanically couple the first compressor to the shaft; and
a second compressor arranged to be selectively engaged by the shaft and configured to deliver a second temperature load which is greater than the first temperature load;
wherein the electric motor, the first compressor and the second compressor are arranged coaxially to one another;
wherein orientation of the first temperature load and orientation of the second temperature load are in a same direction; and
wherein the coupling unit is further configured to couple and decouple the first compressor based upon system flow-through requirements.

20. A method of affecting a temperature change at a location, the method comprising the steps of:
arranging a first compressor and a second compressor to be selectively engaged by an electric motor shaft so as to generate a first temperature load and a second temperature load oriented in a same direction;
arranging a coupling unit on the electric motor shaft so as to selectively couple the first compressor to the electric motor shaft;
selectively engaging the first compressor and the second compressor with the electric motor shaft based upon the temperature change such that at a first temperature change which can be satisfied by the first temperature load both the first compressor and the second compressor are driven by the shaft and at second temperature change which cannot be satisfied by the first temperature load only the second compressor is driven by the electric motor shaft;
wherein the second temperature load is greater than the first temperature load; and
wherein orientation of the first temperature load and orientation of the second temperature load are in a same direction.
